(19) United States
(12) Patent Application Publication
(10) Pub. No.: US 2009/0027308 A1
(43) Pub. Date: Jan. 29, 2009

(54) Method for driving plasma display panel, and plasma display device

(76) Inventors: Takashi Sasaki, Miyazaki (JP); Akira Otsuka, Miyazaki (JP); Akihiro Takagi, Miyazaki (JP)

Correspondence Address: MCDERMOTT WILL & EMERY LLP, 600 13TH STREET, N.W., WASHINGTON, DC, 20005-3096, US

(21) Appl. No.: 11/919,629

(22) PCT Filed: Aug. 4, 2005
(86) PCT No.: PCT/JP2005/014350

§ 371 Date: Mar. 21, 2008

(51) Int. Cl. G09G 3/28

(52) U.S. Cl. 345/60

(57) ABSTRACT

Provided is a method for driving plasma display panel capable of changing the quantity of emission in an erasure discharge. The method drives a plasma display panel including a scan electrode drive circuit (3) for driving scan electrodes (112), a sustain electrode drive circuit (2) for driving sustain electrodes (111), an address electrode drive circuit (4) for driving address electrodes (121), and a control circuit (5) for controlling the actions of the individual drive circuits. The individual drive circuits are driven for a reset period, in which one field is divided for actions into a plurality of sub-fields for adjusting the electric charges in cells, for an address period, in which cells to be issued are designated, for a sustain period, in which discharges are repeated with the scan electrodes and the sustain electrodes to cause the emissions of the cells, and for an erase period, in which the quantity of wall charges formed in the cell having emitted finally of the sustain period is reduced. Erasure waveforms of at least two kinds having different emission quantities are selected and applied by the drive method of the erase period. The erasure waveforms are arbitrarily selected for the erase period of each sub-field.

### RELATED APPLICATION

This application is the U.S. National Phase under 35 U.S.C. § 371 of International Application No. PCT/JP2005/014350, filed on Aug. 4, 2005, the disclosure of which Application is incorporated by reference herein.

### TECHNICAL FIELD

The present invention relates to a method for driving an AC type plasma display panel for use in a display device of a personal computer, a workstation and the like, a flat television, a display for displaying advertisements, information and the like.

### BACKGROUND ART

In a conventional three electrode AC type color plasma display, a period in which wall charges are erased or reduced is present at the end of a sustain period (sustain period). The drive waveform has a restrain in polarity and the like for continuation to the next reset period. When the operation pulses applied to scan electrodes have negative polarity, an odd-number of times or an even-numbered times has to be necessarily selected in all sub-fields (SF), as the number of discharges in a sustain period located between a scanning period and a reset period.

As such a method for driving an AC-type color plasma display, it is proposed that in a memory type AC plasma display of a dot matrix type and an address-display-period separation method, at least a set of two electrodes which perform keeping and erasure of a discharge are included, in the process of the above described erasure, one fine-line erase pulse which causes a discharge but shortens the time in which wall charges are formed, or two or three erase pulses in which the pulse width and pulse interval becomes shorter in sequence is or are alternately applied to two electrodes, and the potential of the erase pulse is sequentially reduced (for example, see Patent Document 1). However, in this example, polarity of the charges continued to the subsequent reset is not considered.

Further, it is proposed that in a method for driving a plasma display panel in which a plurality of X electrodes and a plurality of Y electrodes are disposed to be parallel with each other so that each of the Y electrodes is sandwiched between the X electrodes and a plurality of address electrodes are disposed to intersect the X electrodes and the Y electrodes at a space from them, a first display step of performing display by a discharge between each of the Y electrodes and each of one X electrodes adjacent to each of the X electrodes, and a second display step of performing display by a discharge between the Y electrode and the other X electrode adjacent to each of the Y electrodes are separated timewise (for example, see Patent Document 2).
Patent Document 1: Japanese Patent Publication No.
Patent Document 2: Japanese Patent Publication No.

### DISCLOSURE OF THE INVENTION

In the above described conventional drive methods, when the number of sustain discharges is changed, it always needs to be changed by a multiple of two in such a manner as when the number of sustain discharges is an odd number, it is changed to an odd number, and when it is an even number, it is changed to be an even number, and intermediate brightness cannot be expressed. In order to enable the number of sustain discharges including erasure to be any of an odd number and an even number, the polarities of the sustain electrode and the scan electrode in the reset period need to be inversed, and this brings about the problem of complicating the circuit configuration and increasing cost.

The present invention has an object to make an interval of a luminance change of a sustain discharge small by changing a quantity of emission in an erasure discharge while a state of charges before entering a subsequent reset is made equal in a method of driving a plasma display panel and a plasma display device.

For the above described object, in the present invention, intermediate brightness is expressed by changing a quantity of emission of an erasure discharge while a charge state before entering a subsequent reset is made equal. This makes it possible to select an erasure waveform with a large quantity of emission and an erasure waveform with a small quantity of emission can be selected in each erase period.

In the present invention, in a plasma display having scan electrodes and sustain electrodes disposed parallel with a front substrate, having a sustain period in which a discharge is repeated with the scan electrodes and sustain electrodes to cause cells to emit, and a reset period in which a charge quantity in the cells is adjusted, and having an erase period in which a quantity of wall charges formed in the cells having emitted is reduced in the end of the above described sustain period, intermediate brightness is expressed by making it possible to select at least two kinds of erasure waveforms having different emission quantities by the drive method of the above described erase period.

Specifically, the present invention is, in a plasma display device having a plasma display panel having scan electrodes and sustain electrodes disposed in a front substrate to be parallel with one another, address electrodes disposed in a rear substrate in a direction perpendicular to the scan electrodes and the sustain electrodes, and cells formed between the front substrate and the rear substrate, a scan electrode drive circuit which drives the scan electrodes, a sustain electrode drive circuit which drives the sustain electrodes, an address electrode drive circuit which drives the address electrodes, and a control circuit which controls operations of the drive circuits, characterized in that the control circuit divides for action one field into a plurality of sub-fields, and drives each of the drive circuits with each of the sub-fields having a reset period in which a quantity of electric charges in cells is adjusted, an address period in which cells to be caused to emit is designated, a sustain period in which discharges are repeated with the scan electrodes and sustain electrodes to cause the cells to emit, and an erase period in which a quantity of wall charges formed in the cells having emitted is reduced at an end of the sustain period, and the sustain electrode drive circuit and the scan electrode drive circuit have erasure waveforms of at least two kinds having different emission quantities by a drive method of the erase period, and select the erasure waveform of the erase period of each subfield based on a control from the control circuit.

The present invention is in the above described plasma display device, characterized in that the scan electrode drive circuit applies a voltage to the scan electrodes in the reset period so as to have a write step in which a voltage gradually rises to cause discharges in all the cells to form wall discharges, and a reduction step in which the voltage gradually lowers to reduce the wall charges formed in the write step, and by an erasure method with a small emission quantity out of the erasure methods in the erase period, the scan electrode drive circuit applies a slope pulse erasure waveform with an inclination of the voltage waveform applied to the scan electrode made substantially the same as an inclination of a voltage waveform which is applied to the scan electrodes in the reduction step. Further, the present invention is, in the above described plasma display device, characterized in that the sustain electrode drive circuit and the scan electrode drive circuit make a method with a large emission quantity out of the erasure methods in the erase period, a fine-line erase pulse having a width narrower than a width of a sustain pulse which is repeatedly applied in the sustain period. Further, the present invention is, in the above described plasma display device, characterized in that the sustain electrode drive circuit and the scan electrode drive circuit make a method with a large emission quantity out of the erasure methods in the erase period, a fine-line erase pulse having a width narrower than a width of a sustain pulse which is repeatedly applied in the sustain period, and the fine-line erase pulse is repeatedly applied one or a plurality of times by changing a polarity, and a final polarity is always made the same irrespective of the number of repetitions.

The present invention is, in the above described plasma display device, characterized in that the sustain electrode drive circuit and the scan electrode drive circuit makes a method with a large emission quantity out of the erasure methods in the erase period, a self erase pulse lower in voltage than a sustain pulse which is repeatedly applied in the sustain period. Further, the present invention is, in the above described plasma display device, characterized in that the sustain electrode drive circuit and the scan electrode drive circuit make a method with a large emission quantity out of the erasure methods in the erase period, a self erase pulse lower in voltage than a sustain pulse which is repeatedly applied in the sustain period, and a voltage difference between the scan electrodes and the sustain electrodes when performing a self erase discharge is changed in accordance with a display load.

The present invention is, in the above described plasma display device, characterized in that the sustain electrode drive circuit and the scan electrode drive circuit makes a method with a large emission quantity out of the erasure methods in the erase period, a self erase pulse lower in voltage than a sustain pulse which is repeatedly applied in the sustain period, and relative polarities of the scan electrodes and sustain electrodes at a time of a final discharge of the erasure method in the erase period are made the same in any erasure method.

The present invention is, in the above described plasma display device, characterized in that the control circuit controls the number of emissions in accordance with a display load, and in a display load area in which the number of emissions is not reduced, a method with a large emission quantity is applied as the erasure method in the erase period.

The present invention is, in a method for driving a plasma display panel having a plasma display panel having scan electrodes and sustain electrodes disposed in a front substrate to be parallel with one another, address electrodes disposed in a rear substrate in a direction perpendicular to the scan electrodes and the sustain electrodes, and cells formed between the front substrate and the rear substrate, a scan electrode drive circuit which drives the scan electrodes, a sustain electrode drive circuit which drives the sustain electrodes, an address electrode drive circuit which drives the address electrodes, and a control circuit which controls operations of the drive circuits, characterized in that one field is divided for action into a plurality of sub-fields, and each of the drive circuits is driven with each of the sub-fields having a reset period in which a quantity of electric charges in cells is adjusted, an address period in which cells to be caused to emit is designated, a sustain period in which discharges are repeated with the scan electrodes and sustain electrodes to cause the cells to emit, and an erase period in which a quantity of wall charges formed in the cells having emitted is reduced at an end of the sustain period, and erasure waveforms of at least two kinds having different emission quantities can be selected and applied by a drive method of the erase period, and the erasure waveforms are arbitrarily selected in the erase period of each of the sub-fields.

The present invention is, in the above described method for driving a plasma display panel, characterized by including a write step of forming wall discharges by applying a voltage to the scan electrodes in the reset period, and gradually raising the voltage to cause discharges in all the cells, and a reduction step of reducing the wall charges formed in the write step by gradually lowering the voltage, characterized in that in a method with a small emission quantity out of the erasure methods in the erase period, a slope pulse erasure waveform with an inclination of a voltage waveform applied to the scan electrodes and an inclination of a voltage waveform applied to the scan electrode in the reduction step made substantially the same.

The present invention is, in the above described method for driving a plasma display panel, characterized in that a method with a large emission quantity out of the erasure methods in the erase period is made a fine-line erase pulse having a width narrower than a width of a sustain pulse which is repeatedly applied in the sustain period. The present invention is, in the above described method for driving a plasma display panel, characterized in that a method with a large emission amount out of the erasure method in the erase period is made a fine-line erase pulse having a narrower width than that of the sustain pulse repeatedly applied in the sustain period, the fine-line erase pulse is repeatedly applied a plurality of times by changing a polarity, and a final polarity is always made the same irrespective of the number of repetitions. The present invention is, in the above described method for driving a plasma display panel, characterized in that a method with a large emission quantity out of the erasure methods in the erase period is made a self erase pulse lower in voltage than a sustain pulse which is repeatedly applied in the sustain period. The present invention is, in the above described method for driving a plasma display panel, characterized in that a method with a large emission quantity out of the erasure methods in the erase period is made a self erase pulse lower in voltage than a sustain pulse which is repeatedly applied in the sustain period, and a voltage difference between the scan electrodes and the sustain electrodes when performing a self erase discharge is changed in accordance with a display load.

The present invention is, in the above described method for driving a plasma display panel, characterized in that relative polarities of the scan electrodes and sustain electrodes at a time of a final discharge of the erasure method in the erase period are made the same in any erasure method. The present invention is, in the above described method for driving a plasma display panel, characterized in that the number of emissions is controlled in accordance with a display load, and in a display load area in which the number of emissions is not reduced, a method with a large emission quantity is applied as the erasure method in the erase period.

According to the present invention, the emission quantity of an erasure discharge is changed without significantly changing the wall charge state before the reset period, and stable drive can be performed with the luminance ratio of each of the sub-fields kept at a predetermined value.

### BRIEF DESCRIPTION OF THE DRAWINGS

FIG. 1 is a conceptual diagram showing a sub-field configuration of the present invention;

FIG. 2 is an exploded perspective view explaining a structure of a PDP panel of the present invention;

FIG. 3 is a diagram explaining a PDP panel body 1 and a circuit configuration of the present invention;

FIG. 4 is a waveform chart showing an example of drive waveforms in a first embodiment of the present invention;

FIG. 5 is a waveform chart showing an example of drive waveforms in a second embodiment of the present invention;

FIG. 6 is a diagram showing relationship of a load factor, luminance and power; and

FIG. 7 is a waveform chart showing an example of drive waveforms in a third embodiment of the present invention. (Example with a plurality of erase pulses)

### DESCRIPTION OF SYMBOLS

1 PDP panel body
11 Front glass plate
111 X electrode
112 Y electrode
113 Dielectric layer
114 Protection layer
12 Back glass plate
121 Address electrode
123 Bulkhead
124R, G, B Phosphor
X-drive circuit
Y-drive circuit
4 Address drive circuit
51 Y write slope pulse
52 Y compensation slope pulse
41 X write voltage
42 X compensation voltage
43 X voltage
44, 54 First sustain pulse
45, 46, 55, 56 Sustain pulse
47, 57 Erase pulse
48, 49, 50, 58, 59, 60 Fine-line erase pulse
77 Erasure slope pulse
87, 88, 89, 90 Erasure discharge with a large discharge quantity
97 Erasure discharge with a small discharge quantity
SF1 to SF10 Sub-field
RP Reset period
AP Address period
SP Sustain period
CP1, CP2 Erase period

### BEST MODE FOR CARRYING OUT THE INVENTION

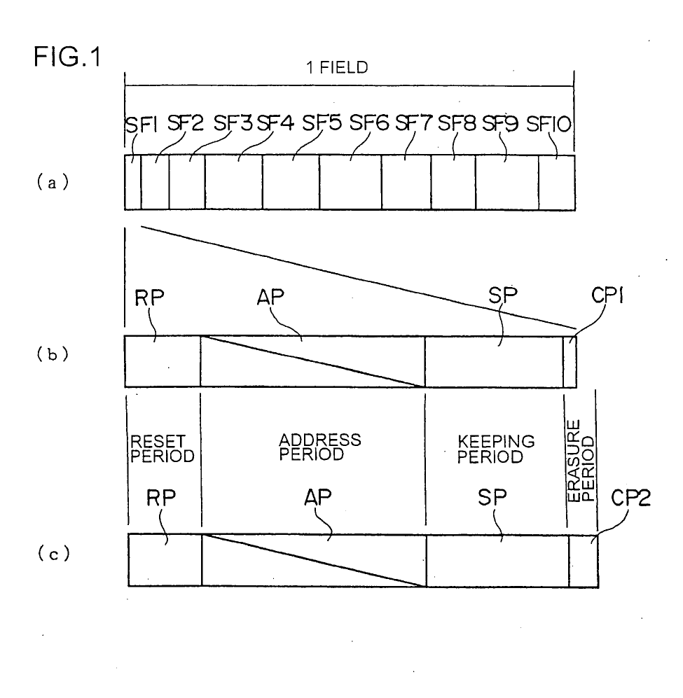

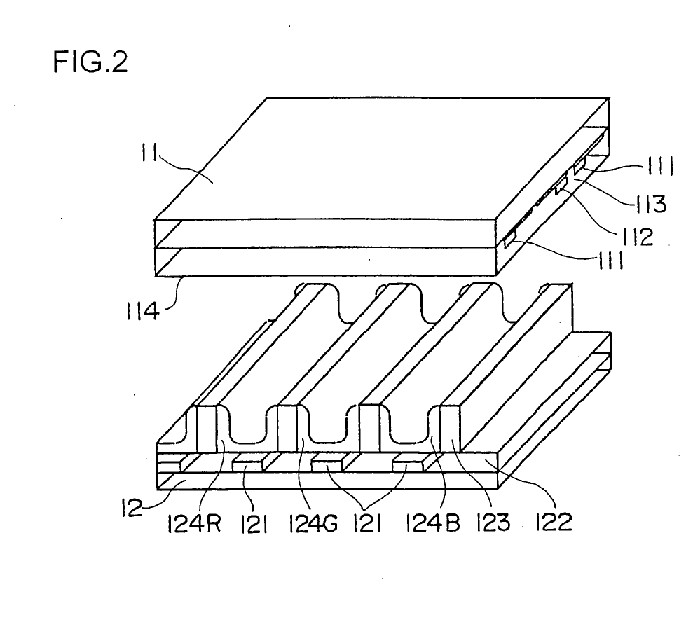

Hereinafter, embodiments of the present invention will be described by using FIG. 1 to FIG. 7. FIG. 2 is an exploded perspective view showing an example of a structure of a PDP panel body 1 according to the present invention. In a front glass plate 11, sustain electrodes 111 and scan electrodes 112 which repeatedly perform discharges are alternately disposed parallel with each other. The electrode group is covered with a dielectric layer 113, and its surface is further covered with a protection layer 114 of MgO or the like. On a back glass plate 12, address electrodes 121 are disposed in a direction substantially orthogonal to the sustain electrodes 111 and the scan electrodes 112, and are further covered with a dielectric layer 122. Bulkheads 123 are disposed on both sides of each of the address electrodes 121 to partition cells in a column direction. Phosphors 124R, 124G and 124B which are excited by ultraviolet light to generate visible light of red (R), Green (G) and blue (B) are coated on the dielectric layer 122 and side surfaces of the bulkheads 123 on the address electrodes 121. The front glass plate 11 and the back glass plate 12 are bonded together so that the protection layer 114 and the bulkheads 123 contact each other, where discharge gas such as Ne—Xe is encapsulated to compose a panel.

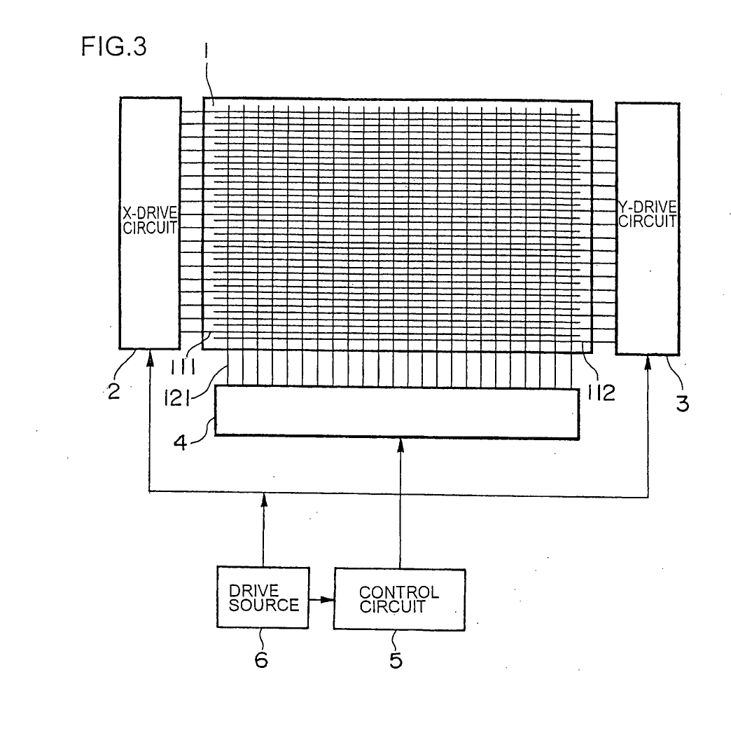

Next, by using FIG. 3, a configuration of a PDP module of the present invention will be described. FIG. 3 shows the PDP panel body 1 composed by bonding the front glass plate 11 and the back glass plate 12 to each other, and drive circuits. In FIG. 3, the PDP module has the PDP panel body 1, an X-drive circuit (sustain electrode drive circuit) 2, a Y-drive circuit (scan electrode drive circuit) 3, an address drive circuit 4, a control circuit 5 and a drive source 6. The sustain electrodes 111, the scan electrodes 111 and the address electrodes 121 of the PDP panel body 1 are respectively connected to the X-drive circuit 2, the Y-drive circuit 3 and the address drive circuit 4.

The X-drive circuit 2 and the Y-drive circuit 3 each have erasure waveforms of at least two kinds having different emission quantities by a drive method of the erase period, arbitrarily select the erasure waveform in the erase period of each sub-frame based on control from the control circuit, and outputs a fine-line erase pulse having a width narrower than the width of a sustain pulse which is repeatedly applied in a sustain period by a method with a large emission quantity among erasure methods in the erase period. The X-drive circuit 2 and the Y-drive circuit 3 outputs a fine-line erase pulse which has a width narrower than the width of the sustain pulse repeatedly applied in the sustain period by the method with a large emission quantities among the erasure methods in the erase period, applies the fine-line erase pulse once or repeatedly plurality of times with the polarity changed, and outputs it so that the final polarity is always the same irrespective of the number of repetitions.

The X-drive circuit 2 and the Y-drive circuit 3 output self erase pulses having a lower voltage than sustain pulses repeatedly applied in the sustain period by a method with a large emission quantity among the erasure methods in the erase period, and outputs it by changing a voltage difference between the scan electrodes 112 and the sustain electrodes 111 at the time of performing a self erase discharge in accordance with a display load. Further, the X-drive circuit 2 and the Y-drive circuit 3 output the self erase pulse having a lower voltage than the sustain pulse repeatedly applied in the sustain period by the method with a large emission quantity among the erasure methods in the erase period, and output it so that the relative polarities of the scan electrodes and the sustain electrodes at the time of the final discharge by the above described erasure method in the erase period are the same in any erasure method.

The X-drive circuit 2 applies an X slope pulse or an X compensation voltage to the X electrodes (sustain electrodes) in a reset period which will be described later, and can output erase pulses of a plurality of methods having different pulse widths or pulse amplitudes in the erase period, and can cause the intensity of discharge emission in the erase period to differ.

The Y-drive circuit 3 applies a Y slope pulse voltage or a Y compensation slope pulse to the Y electrodes (scan electrodes) in the reset period which will be described later, applies a scan pulse in the address period, and can output erase pulses of a plurality of methods having different pulse widths or pulse amplitudes or Y erasure slope pulses in the erase period, and can cause the intensity of a discharge emission in the erase period to differ.

The Y-drive circuit 3 applies a voltage to the scan electrodes 112 in the reset period so as to have a write step in which a voltage gradually rises to cause discharges in all the cells to form wall charges, and a reduction step in which the voltage gradually lowers to reduce the wall charges formed in the above described write step, and outputs a slope pulse erasure waveform with an inclination of a voltage waveform which is applied to the scan electrodes 112 by a method with a small emission quantity among the above described erasure methods in the erase period and an inclination of the voltage waveform which is applied to the scan electrodes 112 in the above described reduction step made substantially the same.

The address drive circuit 4 applies address pulses to the address electrodes 121 in the address period which will be described later.

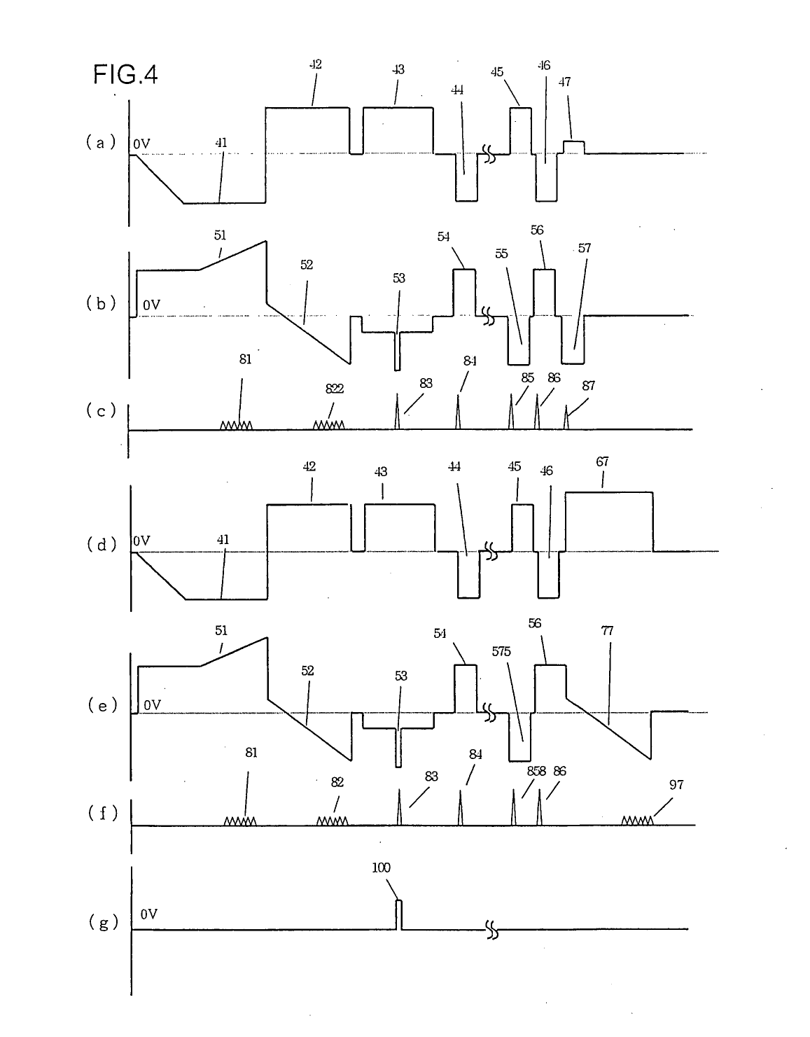

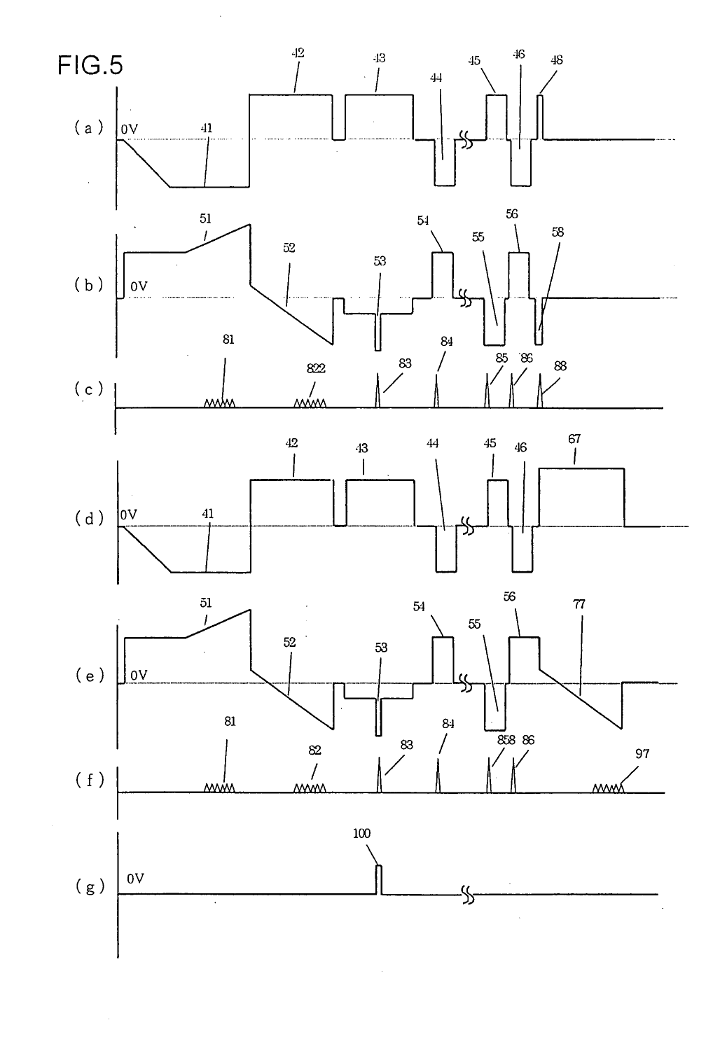

The control circuit 5 controls the X-drive circuit 2, the Y-drive circuit 3 and the address drive circuit 4 with a predetermined timing, and controls them to apply the voltages shown in FIGS. 4 and 5, for example. Specifically, the control circuit 5 is a circuit which divides one field for action into a plurality of sub-fields, and drives each of the drive circuits with each of the sub-field having a reset period in which an electric charge amount in cells is adjusted, an address period in which cells to be caused to emit are designated, a sustain period in which a discharge is repeatedly performed with the above described scan electrodes and the sustain electrodes to cause the cells to emit, and an erase period in which the quantity of wall charges formed in the cells having emitted in the end of the above described sustain period. The control circuit 5 controls the number of emissions in accordance with the display load, and controls to adopt the erasure method with a large emission quantity in the erase period in a display load area in which the number of emissions is not reduced.

Next, by using a schematic diagram in FIG. 1, one example of a drive method when an image of one image (1 field: 1/60 sec) in the address-display-period separation method is displayed will be described. One field is composed of a plurality of sub-fields (10 sub-fields SF1 to SF10 in this example) (FIG. 1(a)). Each of the sub-fields is composed of a reset period RP, an address period AP, a sustain period SP, an erase period CP1 or CP2 having a different emission quantity (FIG. 1(b), (c)). In the reset period RP, relocation of the electric charges in cells is performed for the purpose of assisting a discharge in the subsequent address period AP. There are a method in which electric charges are formed in cells which emit and a method in which electric charges of non-emitting cells are erased, after a discharge for determining the cell to be caused to emit is performed in the address period AP. In this embodiment, the method of forming electric charges in the cells which emit is adopted. The present invention relates to an erase period of a sustain discharge, and therefore, the method of erasing the electric charges in non-emitting cells may be adopted.

In the subsequent sustain period SP, a discharge is repeatedly performed to cause the cell to emit. The present invention relates to the subsequent erase periods CP1 and CP2, where the wall charges formed in the sustain period SP are erased or reduced.

One example of a drive waveform will be described by using FIG. 4. (a) to (g) show the drive waveforms which are applied to the sustain electrodes 111, the scan electrodes 112 and the address electrodes 121 and the discharge emissions on the occasions in the reset periods RP to the erase period CP, respectively. (a) and (d) show the voltage waveforms applied to the sustain electrodes, (b) and (e) show the voltage waveforms applied to the scan electrodes, (c) and (f) show the discharge emissions, and (g) shows the voltage waveform applied to the address electrodes.

First, in the reset period RP, a Y write slope pulse 51 and an X voltage 41 which form electric charges in all the cells are applied to the sustain electrode 111 and the scan electrode 112 in FIGS. 4 (a) and (b). Subsequently, a Y compensation slope pulse 52 and an X compensation voltage 42 which erase the electric charges formed in the cells with only a required amount of electric charges left are applied.

The voltage waveform applied in the next address period AP is a scanning pulse 53 which performs a discharge for determining cells to be displayed to be timed to an address pulse 100 in each row, and an X voltage 43 for forming wall charges by the discharge. The scanning pulse 53 is applied for each row by shifting the timing.

Subsequently, in the sustain period SP, first sustain pulses 44 and 54 and repetition sustain pulses 45, 46, 55 and 56 are applied.

In the erase period CP, erase pulses 47 and 57 are applied. In the erasure method of this example, the erase pulse 47 is lower in voltage than the sustain pulse 45, and the discharge quantity is a little smaller than that of the sustain discharge, but the quantity of formation of the wall charges becomes smaller correspondingly to the amount by which the voltage is lower. The discharge is sometimes called self erase discharge. (g) shows a waveform applied to the address electrodes, and in the cells in which discharge is desired to be caused, the address pulse 100 is applied in correspondence with the scanning pulse 53.

(c) shows emissions of the cell in which discharge occurs with the voltage waveforms of (a), (b) and (g). The emission is not the emission of a phosphor, but is infrared light (or ultraviolet light) which the excited atoms emit when returning to the ground state with the discharge. In the reset period, a write discharge 81 occurs which is weaker than the Y write slope pulse 51. In the Y compensation slope pulse 52, a weak discharge 82 occurs. A waveform which gradually changes voltage like this causes a weak discharge, and the emission quantity is small. Accordingly, the quantity of emissions of the phosphors which are excited by ultraviolet light is small.

In the subsequent address period AP, an address discharge 83 occurs by the scanning pulse 53 and the address pulse 100. Further in the sustain period SP, sustain discharges 84, 85 and 86 occur, and an erasure discharge 87 subsequently occurs. The erasure discharge 87 corresponds to one emission quantity of the sustain discharge though the discharge quantity is slightly smaller than that of the sustain discharge. In this discharge, a small quantity of positive wall charges is formed near the scan electrode, and a small quantity of negative wall charges is formed near the sustain electrode.

Next, (d) and (e) show the case of applying erasure waveforms having different emission quantities in the erase period CP. The drive waveforms in the reset period RP, the address period AP and the sustain period SP except for the erase period CP are the same as those shown in (a) and (b), and the explanation thereof will be omitted. As the erasure waveform of this example, an erasure slope pulse 77 similar to the Y compensation slope pulse 52 which is applied to the scan electrode 112 in the reset period RP is applied to the scan electrode 112. At this time, a voltage 67 which is applied to the sustain electrode 111 is set to be higher than the voltage 42 which is applied in the reset period RP.

(f) shows the emission of the cell in which discharge occurs with the voltage waveforms of (d), (e) and (g), and the explanation of the discharge which is the same as (c) will be omitted. The erasure discharge of this method is a very weak discharge 97, and the emission quantity in this discharge is about 1/10 as compared with the emission quantity of one sustain discharge. In this discharge, a small quantity of positive wall charges is formed near the scan electrode, and a small quantity of negative wall charges are formed near the sustain electrode.

As is obvious when the light emissions shown in the above (c) and (f) are compared, the numbers of sustain discharges including the erasure discharge are the same, but the emission quantities differ from each other by the quantity of substantially one sustain discharge, and by selecting the method of the erasure discharge, the emission quantity of each of the sub-fields can be adjusted. In both the erasure methods, the wall charges after the erasure discharge are in the similar states, and the subsequent reset waveform does not have to be changed.

Next, by FIG. 5, a second embodiment will be described. The second embodiment differs from the first embodiment shown in FIG. 4 in the erasure waveforms shown in (a) and (b), and the explanation of the other points than this will be omitted by assigning them with the same reference numerals as those in FIG. 4. The erasure method in this embodiment is a so-called fine line erasure method, in which a discharge is performed at the same voltage as the sustain pulse, but the quantity of formation of wall charges is reduced by the fine line erase pulses 48 and 58 with the pulse width shortened. The emission quantity of this case is the same as the emission quantity of the sustain discharge as shown in (c). In this discharge, a small quantity of positive wall charges is also formed near the scan electrode, and a small quantity of negative wall charges is formed near the sustain electrode, which is the same as in the first embodiment.

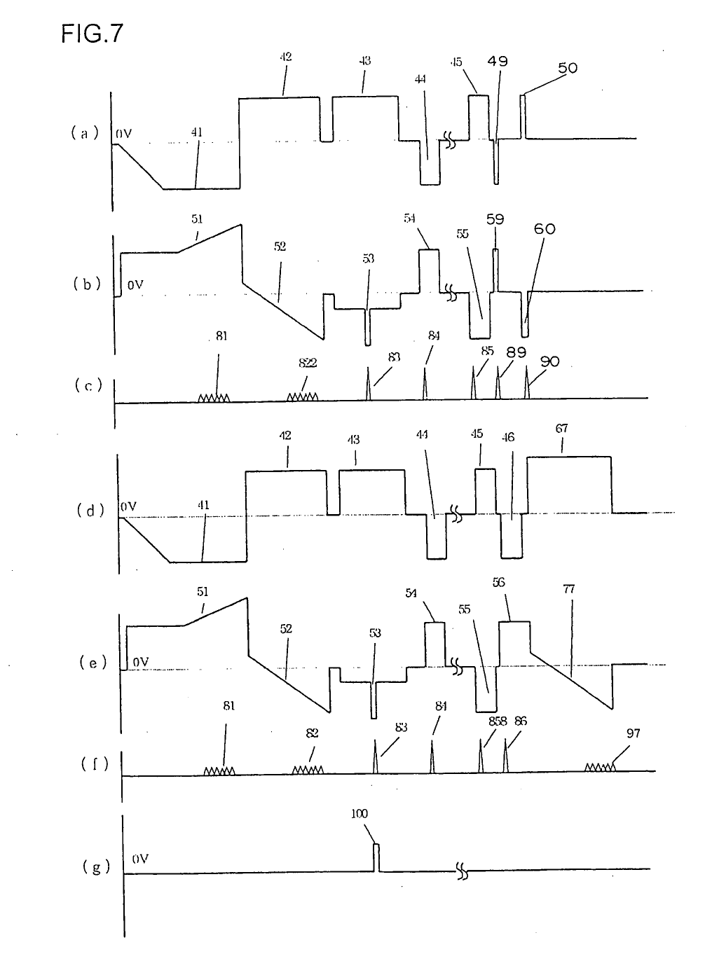

Next, by FIG. 7, a third embodiment will be described. The third embodiment differs from the second embodiment shown in FIG. 5 in the erasure waveforms shown in (a) and (b), and the explanation of the other points than this will be omitted by assigning them with the same reference numerals as in FIG. 5. The erasure method in this embodiment is a so-called fine-line erasure method, in which a discharge is performed at the same voltage as the sustain pulse, but the quantity of formation of wall charges is reduced by fine-line erase pulses 49, 59, 50 and 60 with the pulses sequentially shortened. The quantity of emission of this case is the same as the emission quantity of the sustain discharge as shown in (c). In this example, the number of discharges is made equal by replacing the sustain pulse immediately before the erase pulse shown in FIG. 5 with the fine line erase pulse. In this erasure discharge, after the final erasure discharge, a small quantity of positive wall charges is also formed near the scan electrode and a small quantity of negative wall charges is formed near the sustain electrode, which is the same as in the first embodiment.

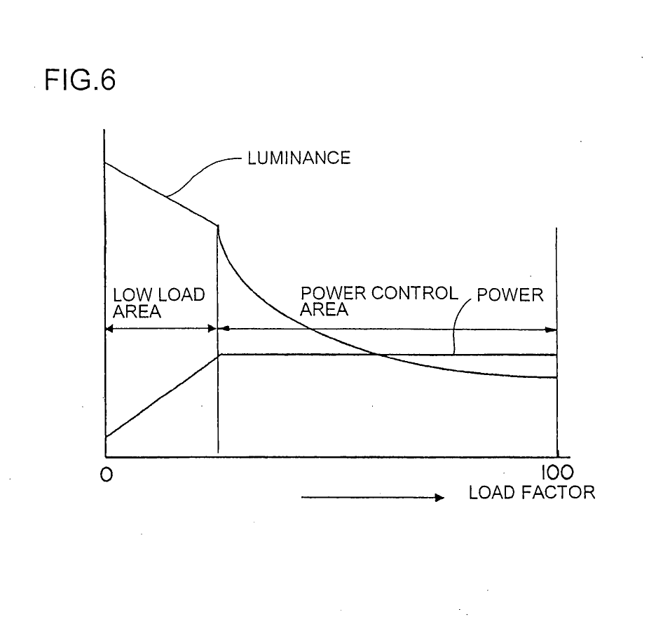

By using FIG. 6, the relationship of the display load factor, power and the luminance in the plasma display will be described. A control to reduce the number of sustain pulses is generally performed so as to keep the power at a predetermined value or less when the load factor becomes large. In this case, the number of sustain pulses is not controlled at the low load area side, and therefore, the luminance ratio of each of the sub-fields becomes a predetermined value. Accordingly, in this area, the erasure waveform having high luminance is desirably selected. Since the number of discharges is changed twice in the power control area in which the number of sustain pulses is controlled, it is difficult to always keep the luminance ratio of each of the sub-fields, and the luminance ratio of each sub-field can be kept at a predetermined value by adjusting the luminance of one discharge by selection of the erasure method as in this embodiment.

1. A method for driving a plasma display panel having a plasma display panel having scan electrodes and sustain electrodes disposed in a front substrate to be parallel with one another, address electrodes disposed in a rear substrate in a direction perpendicular to the scan electrodes and the sustain electrodes, and cells formed between the front substrate and the rear substrate, a scan electrode drive circuit which drives the scan electrodes, a sustain electrode drive circuit which drives the sustain electrodes, an address electrode drive circuit which drives the address electrodes, and a control circuit which controls operations of the drive circuits, characterized in that
one field is divided for action into a plurality of sub-fields, and each of the drive circuits is driven with each of the sub-fields having a reset period in which a quantity of electric charges in cells is adjusted, an address period in which cells to be caused to emit is designated, a sustain period in which discharges are repeated with the scan electrodes and sustain electrodes to cause the cells to emit, and an erase period in which a quantity of wall charges formed in the cells having emitted is reduced at an end of the sustain period, and
erasure waveforms of at least two kinds having different emission quantities can be selected and applied by a drive method of the erase period, and the erasure waveforms are arbitrarily selected in the erase period of each of the sub-fields.

2. The method for driving a plasma display panel according to claim 1, characterized by comprising:
a write step of forming wall discharges by applying a voltage to the scan electrodes in the reset period, and gradually raising the voltage to cause discharges in all the cells, and a reduction step of reducing the wall charges formed in the write step by gradually lowering the voltage, characterized in that
in an erasure wave pattern with a small emission quantity out of the erasure wave patterns in the erase period, a slope pulse erasure waveform having an inclination substantially the same as an inclination of a voltage waveform which is applied to the scan electrodes in the reduction step is applied to the scan electrodes.

3. The method for driving a plasma display panel according to claim 1, characterized in that
in an erasure method with a large emission quantity out of the erasure methods in the erase period, a fine-line erase pulse having a width narrower than a width of a sustain pulse which is repeatedly applied from the sustain electrode drive circuit and the scan electrode drive circuit sustain period.

4. The method for driving a plasma display panel according to claim 3, characterized in that
the fine-line erase pulse is repeatedly applied a plurality of times by changing a polarity, and a final polarity is always made the same irrespective of the number of repetitions.

5. The method for driving a plasma display panel according to claim 1, characterized in that
in an erasure method with a large emission quantity out of the erasure methods in the erase period, a self erase pulse lower in voltage than a sustain pulse which is repeatedly applied in the sustain period is applied from the sustain electrode drive circuit and the scan electrode drive circuit sustain period.

6. The method for driving a plasma display panel according to claim 1, characterized in that
in an erasure method with a large emission quantity out of the erasure methods in the erase period, a self erase pulse lower in voltage than a sustain pulse which is repeatedly applied in the sustain period is applied from the sustain electrode drive circuit and scan electrode drive circuit sustain period, and a voltage difference between the scan electrodes and the sustain electrodes when performing a self erase discharge is changed in accordance with a display load.

7. The method for driving a plasma display panel according to claim 1, characterized in that
relative polarities of the scan electrodes and sustain electrodes at a time of a final discharge of the erasure method in the erase period are made the same in any erasure method.

8. The method for driving a plasma display panel according to claim 1, characterized in that
the number of emissions is controlled in accordance with a display load, and in a display load area in which the number of emissions is not reduced, a method with a large emission quantity is applied as the erasure method in the erase period.

9. A plasma display device, characterized by comprising:
a plasma display panel having scan electrodes and sustain electrodes disposed in a front substrate to be parallel with one another, address electrodes disposed in a rear substrate in a direction perpendicular to the scan electrodes and the sustain electrodes, and cells formed between the front substrate and the rear substrate;
a scan electrode drive circuit which drives the scan electrodes;
a sustain electrode drive circuit which drives the sustain electrodes;
an address electrode drive circuit which drives the address electrodes; and
a control circuit which controls operations of the scan electrode drive circuit, the sustain electrode drive circuit and the address electrode drive circuit, characterized in that
the control circuit divides one field for action into a plurality of sub-fields, and drives each of the drive circuits with each of the sub-fields having a reset period in which a quantity of electric charges in cells is adjusted, an address period in which cells to be caused to emit is designated, a sustain period in which discharges are repeated with the scan electrodes and sustain electrodes to cause the cells to emit, and an erase period in which a quantity of wall charges formed in the cells having emitted is reduced at an end of the sustain period, and
the sustain electrode drive circuit and the scan electrode drive circuit have erasure waveforms of at least two kinds having different emission quantities by a drive method of the erase period, and select the erasure waveform of the erase period based on a control from the control circuit.

10. The plasma display device according to claim 9, characterized in that
the scan electrode drive circuit
applies a voltage to the scan electrodes in the reset period so as to have a write step in which a voltage gradually rises to cause discharges in all the cells to form wall discharges, and a reduction step in which the voltage gradually lowers to reduce the wall charges formed in the write step, and
in an erasure method with a small emission quantity out of the erasure methods in the erase period, the scan electrode drive circuit applies a slope pulse erasure waveform having an inclination substantially the same as an inclination of a voltage waveform which is applied to the scan electrodes in the reduction step, to the scan electrodes.

11. The plasma display device according to claim 9, characterized in that
in an erasure method with a large emission quantity out of the erasure methods in the erase period, a fine-line erase pulse having a width narrower than a width of a sustain pulse which is repeatedly applied from the sustain electrode drive circuit and the scan electrode drive circuit sustain period is applied.

12. The plasma display device according to claim 9, characterized in that
the fine-line erase pulse is repeatedly applied a plurality of times by changing a polarity, and a final polarity is always made the same irrespective of the number of repetitions.

13. The plasma display device according to claim 9, characterized in that
in an erasure method with a large emission quantity out of the erasure methods in the erase period, a self erase pulse lower in voltage than a sustain pulse which is repeatedly applied in the sustain period is applied from the sustain electrode drive circuit and the scan electrode drive circuit sustain period.

14. The plasma display device according to claim 9, characterized in that
in an erasure method with a large emission quantity out of the erasure methods in the erase period, a self erase pulse lower in voltage than a sustain pulse which is repeatedly applied in the sustain period is applied from the sustain electrode drive circuit and scan electrode drive circuit sustain period, and a voltage difference between the scan electrodes and the sustain electrodes when performing a self erase discharge is changed in accordance with a display load.

15. The plasma display device according to claim 9, characterized in that
in an erasure method with a large emission quantity out of the erasure methods in the erase period, a self erase pulse lower in voltage than a sustain pulse which is repeatedly applied in the sustain period is applied from the sustain electrode drive circuit and scan electrode drive circuit sustain period, and
relative polarities of the scan electrodes and sustain electrodes at a time of a final discharge of the erasure method in the erase period are made the same in any erasure method.

16. The plasma display device according to claim 9, characterized in that
the control circuit controls the number of emissions in accordance with a display load, and in a display load area in which the number of emissions is not reduced, a method with a large emission quantity is applied as the erasure method in the erase period.
